(19) United States
(12) Patent Application Publication
(10) Pub. No.: US 2010/0266486 A1
(43) Pub. Date: Oct. 21, 2010

(54) Process for the Manufacture of Rutile Titanium Dioxide Powders

(76) Inventors: Stijn Put, Turnhout (BE); Yves Van Rompaey, Westerlo (BE)

Correspondence Address: BRINKS, HOFER, GILSON & LIONE, P.O. BOX 1340, MORRISVILLE, NC, 27560, US

(21) Appl. No.: 12/742,124

(22) PCT Filed: Nov. 4, 2008
(86) PCT No.: PCT/EP08/09261

§ 371 Date: Jun. 25, 2010

Related U.S. Application Data
(60) Provisional application No. 60/996,481, filed on Nov. 20, 2007.

(30) Foreign Application Priority Data
Nov. 15, 2007 (EP) 07022167.6

(51) Int. Cl. C01G 23/047; C01G 23/04

(52) U.S. Cl. 423/598; 423/610; 423/611; 423/615

(57) ABSTRACT

This invention pertains to a process for producing ultra-fine rutile titanium dioxide powders. This particular compound is useful as UV-blocker in paints, plastics, coatings, pigments and sunscreens. The new process comprises the steps of providing a hot gas stream and of introducing therein firstly:—a titanium-bearing first reactant; and—a carbon- and/or nitrogen-bearing second reactant; the temperature of said gas stream being chosen so as to vaporize said first and second reactants, these being selected so as to form, at the prevalent temperature, titanium carbide, titanium nitride or a mixture thereof, as a nano-sized precursor; and, thereafter:—a volatile oxygen-bearing reactant selected so as to react with the nano-sized precursor, converting it to nano-sized titanium dioxide powder having a rutile content of at least 50%. This reaction scheme allows for the manufacture of powders with or without doping elements with a primary particle size between 1 and 100 nm.

This invention pertains to processes for producing ultra-fine rutile titanium dioxide powders.

Titanium dioxide is capable of crystallizing into three different forms, namely anatase, rutile and brookite. Methods of making ultra-fine titanium dioxide powders include gas phase synthesis, colloidal precipitation and mechanical grinding. Important challenges to face are control of the crystal phase, the particle size and distribution, the degree of agglomeration and aggregation of the particles, and the degree of doping.

During gas phase synthesis, the particle size and distribution of TiO₂ can be controlled by rapid quench methods as explained in U.S. Pat. No. 5,935,293 and U.S. Pat. No. 5,851,507, or by using low flame temperatures and short residence times as shown in U.S. Pat. No. 5,698,177 and by Akhtar et al., Dopants in Vapor-phase synthesis of titania, J. Am. Ceram. Soc. 75[12], 3408-16, 1992. EP-1514846 describes a method for eliminating over-sized particles in the vapour phase synthesis of metal oxide-containing particles, comprising reacting oxygen with one of more vapour streams comprising a titanium halide, a silicon halide, and a compound selected from the group consisting of phosphorus, germanium, boron, tin, niobium, chromium, silver, gold, palladium, aluminium, and mixtures thereof.

Other methods are related to control of the crystal structure of TiO₂, either anatase or rutile. The most obvious method of making rutile TiO₂ powder is by calcination of anatase at temperatures of at least 900° C. However, such high temperatures will cause an undesired sacrifice in particle size and particle size distribution because of sintering and aggregation of the particles. Alternatively, rutile-promoting additives can be added. In GB-1031647, U.S. Pat. No. 2,559,638 and U.S. Pat. No. 3,214,284, aluminium trichloride is added to titanium tetrachloride as rutile promoting additive, thereby achieving a rutile yield of more than 99%. This same result is reported to occur when zirconium or zinc compounds are added. U.S. Pat. No. 5,536,487 describes the manufacture of titanium dioxide by the chloride process, into which aluminium trichloride and one or more particle size control compounds are added. In EP-1138632, it is found that the photocatalytic activity of titanium dioxides in optionally acidified aqueous suspension can be either increased or reduced by doping with oxides of (noble) metals or metalloids. Moreover, a change in the amount of doping component leads to a change in the rate of photocatalytic degradation. However, undoped rutile TiO₂ powders can not be produced by these methods.

Rutile TiO₂ powders are used in UV blocking compositions, e.g. in paints, plastics, coatings, pigments and sunscreens. Titanium dioxide absorbs UV light efficiently, but it also tends to catalyse the formation of super-oxide and hydroxyl radicals, which may initiate unwanted oxidation reactions. Such photo-oxidations may explain the ability of illuminated titanium dioxide to degrade organic matter. As titanium dioxide, when present in sunscreens, may enter human cells, the ability of illuminated titanium dioxide to cause DNA damage has also been a matter of investigations. EP-1079796 provides UV screening compositions that address the above problem, by incorporating manganese or chromium in a rutile titanium dioxide host lattice. Unfortunately, neither manganese nor chromium are effective rutile-promoting additives.

The present invention provides a method of producing ultra-fine titanium dioxide powders. A rutile yield above 50%, above 90, or even above 99% can be obtained. The reaction scheme allows producing powders with or without doping elements. Typically, particles with an average primary particle size between 1 and 100 nm can be made by the process of this invention. Accordingly, a new process for the production of rutile TiO₂ powder is divulged, comprising the steps of providing a hot gas stream and of introducing therein, firstly:
a titanium-bearing first reactant; and
a carbon- and/or nitrogen-bearing second reactant;
   the temperature of said gas stream being chosen so as to vaporize said first and second reactants, the reactants being selected so as to form, at the prevalent temperature, titanium carbide, titanium nitride or a mixture thereof, as a nano-sized precursor; and, thereafter:
a volatile oxygen-bearing reactant selected so as to react with the nano-sized precursor, converting it to nano-sized titanium dioxide powder having a rutile content of at least 50%.

This latter reaction is assumed to be heterogeneous, the carbide and/or nitride particles from the first step being converted to oxide by the volatile (i.e. gaseous at the prevalent temperature) reactant in the second step, while remaining in the solid state. It is believed that, due to the cubic crystal structure of the carbide and/or nitride precursor, the formation of rutile is strongly promoted compared to the formation of anatase during subsequent oxidation.

The initial gas stream temperature is chosen so as to preferably result, after introduction of the reactants, in a gas stream above 1000 K. This is to ensure adequate reaction kinetics for the formation of the carbide and/or nitride precursor. However, if oxygen and carbon are present, originating from the gas stream itself or from the first and second reactants, a Carbon/O₂ ratio of at least 0.5, and a temperature above 1800 K are preferred. Otherwise, undesired anatase TiO₂ may form irreversibly in this step. By Carbon/O₂ ratio is meant: the molar ratio of the total amount of carbon to the total amount of oxygen (expressed as O₂) in all species present in the gas stream in the first process step.

Once the precursor is formed, and if the gas temperature is higher than about 2000 K, it is advisable to quench the gas stream to below 2000 K. This is to avoid grain-growth of the carbide/nitride particles, and also to avoid melting the TiO₂ when it is synthesised in the second process step. Such a particle meltdown might indeed interfere with the rutile-promoting effect of the precursor.

It is also advisable to quench the gas stream after the step of introducing an oxygen-bearing reactant. A temperature down to 600 K is preferred, to avoid grain-growth of rutile in the second step.

The hot gas stream may advantageously be generated by means of either one of a gas burner, a hot-wall reactor, an RF plasma, and a DC arc plasma.

Preferred titanium-bearing first reactants comprise either one or more of titanium chloride, oxide, sulphate, and organo-metallic compounds.

Preferred carbon- and/or nitrogen-bearing second reactants comprise either one or more of carbon, carbonate, carbon monoxide, carbon dioxide, hydro-carbons, nitrogen, amines, and nitrous oxide.

Preferred oxygen-bearing reactants comprise air, oxygen, carbon dioxide, and nitric oxide.

It can be advantageous to introduce both the first and the second reactants simultaneously in the hot gas stream.

In a particularly advantageous embodiment, the titanium-bearing first reactant and the carbon- and/or nitrogen-bearing second reactant are actually a single compound that will vaporize and form the needed nano-sized precursor upon heating. Such a single compound is e.g. titanium isopropoxide.

The oxygen-bearing reactant could advantageously be air.

Another embodiment of the process concerns the synthesis of metal-doped rutile. To this end, an additional metal-bearing compound, which has to be volatile at the prevalent reaction temperature of the first step, is introduced in the hot gas stream, together with the firstly introduced reactants. This metal-bearing compound preferably contains manganese, more preferably as an organic compound. In this case, the amount of the manganese-bearing compound is preferably adjusted so as to obtain a doping level of between 0.01 and 30 wt % in the rutile.

The invention is further illustrated by the following examples. Table 1 summarizes the results obtained when using an inductively coupled plasma torch as a hot gas generator.

### EXAMPLE 1

A 25 kW radio frequency (RF) inductively coupled plasma (ICP) is used, using an argon/nitrogen plasma with 12 Nm³/h argon and 3 Nm³/h nitrogen gas. Titanium isopropoxide is injected in the plasma at a rate of 1 l/h, resulting in a prevalent (i.e. in the reaction zone) temperature above 2000 K in this first process step, wherein the titanium isopropoxide is totally vaporized, whereupon it readily nucleates, forming a cubic TiC nano-powder. A nitrogen flow of 5 Nm³/h is used as quench gas immediately downstream of the reaction zone. This lowers the temperature of the gas to below 2000 K. Further downstream, 10 Nm³/h of air is blown into the gas stream, thereby triggering the second process step whereby the TiC powder is oxidized to nano-sized rutile TiO₂. Any residual carbon is also oxidised in this step. After filtering, nano-sized TiO₂ powder is obtained, having a rutile content of 97±2% and a specific surface area of 25±2 m²/g. This corresponds with a mean primary particle size of about 60 nm.

### EXAMPLE 2

The apparatus according to Example 1 is operated in similar conditions. However, along with titanium isopropoxide, manganese iso-octoate is injected in the plasma, at a total injection rate of 1 l/h. After filtering, nano-sized manganese doped TiO₂ powder is obtained, having a rutile content of 97±2%, a specific surface area of 25±2 m²/g, and a Mn content of 0.67±0.02%.

### EXAMPLE 3

A 250 kW direct current (DC) plasma torch is used, with nitrogen as plasma gas. The gasses exit the plasma at a rate of 150 Nm³/h. A mixture of titanium isopropoxide and manganese iso-octoate is injected downstream of the plasma, at a rate of 25 kg/h. In this step, the reactants are vaporised, resulting in a prevalent gas temperature of 2200 K, and nucleate as a Mn-doped TiC powder. Subsequently, a nitrogen gas flow of 160 Nm³/h is applied in order to reduce the gas temperature. Further downstream, air is blown at a flow rate of 6000 Nm³/h, thereby oxidizing the TiC into nano-sized rutile TiO₂. After filtering, doped nano-powder is obtained, with a rutile content of 97±2%, a Mn content of 0.67±0.02%, and a specific surface area of 18±2 m²/g, which corresponds with a mean primary particle size of about 80 nm.

### EXAMPLE 4

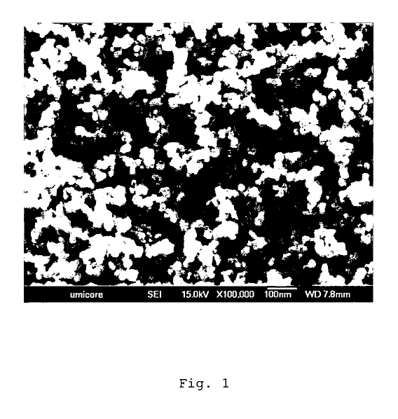

This example is similar to Example 3. However, the mixture titanium isopropoxide and manganese iso-octoate reactants is injected at a much higher rate, namely at 100 kg/h. this results in a prevalent temperature of 1100 K only. Subsequently, a nitrogen gas flow of 200 Nm³/h is applied in order to reduce the gas temperature. Further downstream, air is blown at a flow rate of 15000 Nm³/h. After filtering, doped nano-powder is obtained, with a rutile content of 99±1%, a Mn content of 0.67±0.02%, and a specific surface area of 25±2 m²/g. An FEG-SEM micrograph of the particles is shown in FIG. 1, illustrating doped nano-sized TiO₂ powder with an average primary particle size below 100 nm. This example shows that a relatively low reaction temperature in the first process step, down to about 1000 K, does not impair the rutile yield.

### EXAMPLE 5

A 50 kW RF ICP is used, using a plasma with 12 Nm³/h argon and 3 Nm³/h nitrogen gas. Titanium isopropoxide is injected in the plasma at rate of 500 ml/h, resulting in a prevalent temperature above 3000 K. As described above, titanium isopropoxide is totally vaporized, whereupon TiC is formed. Subsequently, a nitrogen flow of 5 Nm³/h is used as quench gas. In this case, the obtained powder is not further oxidised. After filtering, nano-sized TiC powder is obtained, having a specific surface area of 40±4 m²/g. This result appears to validate the mechanism described in this invention, namely the formation of an intermediate carbide (in this example).

### EXAMPLE 6

This example is similar to Example 1. However, titanium isopropoxide is injected in the plasma at a rate of 500 ml/h only. After filtering, nano-sized TiO₂ powder is obtained, having a rutile content of 97±2% and a specific surface area of 22±2 m²/g. No critical dependency of the reactant flow rate is thus observed.

### EXAMPLES 7-9 AND COMPARATIVE EXAMPLE 10

These examples are similar to Example 1. However, variable oxygen flow rates of respectively 0.2, 0.5, 1 and 3 Nm³/h are injected in the plasma, together with argon or argon/nitrogen. All obtained powders reveal specific surface in the range of 20 to 25 m²/g. At Carbon/O₂ ratios of respectively 2.2, 0.9, 0.45 and 0.15, the rutile yield is, respectively, 95, 90, 50 and 35%. At Carbon/O₂ ratios above 0.5, adequate rutile contents, i.e. of more than 50%, are obtained. However, in the latter case (comparative Example 10, Carbon/O₂ of 0.15), most carbon gets oxidised in the plasma, leaving an insufficient amount of free carbon for the synthesis of the required TiC intermediate. Consequently, too low a rutile yield is obtained.

### EXAMPLE 11

A 50 kW RF ICP according to Example 5 is used. However, the plasma gas is substituted for argon/ammonia, with 12 Nm³/h argon and 3 Nm³/h ammonia. Titanium chloride is injected in the plasma, at rate of 1 l/h, resulting in an average temperature above 2000 K. By analogy with the above examples, the titanium chloride is totally vaporized, whereupon it readily nucleates, forming a cubic TiN nano-powder. Subsequently, a nitrogen flow of 5 Nm³/h is used as a quench gas. Further downstream, 10 Nm³/h of air is blown, thereby oxidizing the powder and producing nano-sized rutile TiO₂. After filtering, nano-sized TiO₂ powder is obtained, having a rutile content of 95±5% and a specific surface area of 25±4 m²/g.

TABLE 1
Experimental conditions for the production of nano-sized manganese doped TiO₂ using ICP

| Conditions | Example 1 | Example 5 | Example 6 | Example 7 | Example 8 | Example 9 | Example 10 | Example 11 |
|---|---|---|---|---|---|---|---|---|
| Plasma gas | Ar/N₂ | Ar/N₂ | Ar/N₂ | Ar/N₂/O₂ | Ar/N₂/O₂ | Ar/O₂ | Ar/O₂ | Ar/NH₃ |
| Plasma gas flow | 12/3 | 12/3 | 12/3 | 12/2.8/0.2 | 12/2.5/0.5 | 12/1 | 12/3 | 12/3 |
| (Nm³/h) | | | | | | | | |
| (C₁₂H₂₈O₄Ti) (l/h) | 1 | 0.5 | 0.5 | 0.5 | 0.5 | 0.5 | 0.5 | 1 (TiCl₄) |
| Carbon/O₂ ratio | >2.2 | >2.2 | >2.2 | 2.2 | 0.9 | 0.45 | 0.15 | — |
| First quench | N₂ | N₂ | N₂ | N₂ | N₂ | N₂ | N₂ | N₂ |
| First quench gas | 5 | 5 | 5 | 5 | 5 | 5 | 5 | 5 |
| flow (Nm³/h) | | | | | | | | |
| Second quench | Air | — | Air | Air | Air | Air | Air | Air |
| gases | | | | | | | | |
| Second quench | 10 | 0 | 10 | 10 | 10 | 10 | 10 | 10 |
| flow (Nm³/h) | | | | | | | | |
| End product | TiO₂ | TiC | TiO₂ | TiO₂ | TiO₂ | TiO₂ | TiO₂ | TiO₂ |
| Specific surface | 20 | 40 | 22 | 22 | 22 | 23 | 25 | 25 |
| area (m²/g) | | | | | | | | |
| Rutile TiO2 | 97 | — | 97 | 95 | 90 | 50 | 35 | 95 |
| content (wt %) | | | | | | | | |

1-14. (canceled)

15. A process for the production of a nano-sized rutile powder comprising:
providing a hot gas stream;
introducing a titanium-bearing first reactant and a carbon- and/or nitrogen-bearing second reactant to the hot gas stream, wherein the temperature of said hot gas stream is chosen to vaporize said first and second reactants, said reactants being selected to form, at the prevalent temperature, titanium carbide, titanium nitride or a mixture thereof, as a nano-sized precursor; and
thereafter introducing a volatile oxygen-bearing reactant to said precursor, wherein the volatile oxygen-bearing reactant is selected to react with the nano-sized precursor, thereby converting the nano-sized precursor to nano-sized titanium dioxide powder having a rutile content of at least 50%.

16. The process of claim 15, wherein, before introducing the volatile oxygen-bearing reactant, the hot gas stream is quenched.

17. The process of claim 15, wherein, after introducing the volatile oxygen-bearing reactant, the hot gas stream is quenched.

18. The process of claim 15, wherein the hot gas stream is generated by a gas burner, a hot-wall reactor, an RF plasma, or a DC arc plasma.

19. The process of claim 15, wherein the titanium-bearing first reactant comprises either one or more of a titanium chloride, an oxide, a sulphate, or an organometallic titanium compound.

20. The process of claim 15, wherein the carbon- and/or nitrogen-bearing second reactant comprises either one or more of carbon, carbonate, carbon monoxide, carbon dioxide, hydro-carbons, nitrogen, amines or nitrous oxide.

21. The process of claim 15, wherein the oxygen-bearing reactant comprises air, oxygen, carbon dioxide or nitric oxide.

22. The process of claim 15, wherein the titanium-bearing first reactant and the carbon- and/or nitrogen-bearing second reactant are introduced simultaneously to the hot gas stream.

23. The process of claim 22, wherein the titanium-bearing first reactant and the carbon- and/or nitrogen-bearing second reactant are embodied as a single compound.

24. The process of claim 23, wherein said single compound is titanium isopropoxide.

25. The process of claim 15, wherein the oxygen-bearing reactant is air.

26. The process of claim 15, wherein an additional volatile metal-bearing compound is introduced in the hot gas stream, together with the first reactant and the second reactant, thereby forming a metal-doped rutile.

27. The process of claim 26, wherein said additional metal-bearing compound comprises manganese.

28. The process of claim 27, wherein the amount of said additional manganese-bearing compound is adjusted to obtain a doping level of between 0.01 and 30 wt % in the rutile.

29. The process of claim 27, wherein the additional metal-bearing compound is an organic compound.
